(19) United States
(12) Patent Application Publication
(10) Pub. No.: US 2013/0046603 A1
(43) Pub. Date: Feb. 21, 2013

(54) METHOD OF PROVIDING AN OFFER BASED ON A PROJECTED PATH TRIGGERED BY A POINT OF SALE TRANSACTION

(71) Applicants: David M. Grigg, Rock Hill, SC (US); Matthew A. Calman, Charlotte, NC (US); Raja Bose, Charlotte, NC (US); Erik Stephen Ross, Charlotte, NC (US)

(72) Inventors: David M. Grigg, Rock Hill, SC (US); Matthew A. Calman, Charlotte, NC (US); Raja Bose, Charlotte, NC (US); Erik Stephen Ross, Charlotte, NC (US)

(73) Assignee: BANK OF AMERICA CORPORATION, Charlotte, NC (US)

(21) Appl. No.: 13/212,102

(22) Filed: Aug. 17, 2011

(51) Int. Cl. G06Q 30/00

(52) U.S. Cl. 705/14.25; 705/14.38

(57) ABSTRACT

Embodiments of the invention include systems, methods, and computer-program products that provide for a unique offer determination system. In one embodiment of the invention, offers are provided based on a projected path of a user triggered by a transaction at a point-of-transaction device. The system receives data associated with a transaction at a point-of-transaction device, determines the identity of the user conducting the transaction, predicts a projected path or future action of the user based on the transaction, and provides an offer to the user based on the projected path. In an embodiment, the system predicts the projected path based on pattern recognition analysis of the user's transaction history.

### BACKGROUND

Currently, businesses offer products and services to customers based on the customer's known place of residence or to customers who reside within the geographic area of the business. These offers, however, are not directed to customers that are already shopping. Further, these offers are not specific to the customer's behavior. For this reason, the offers provided by the businesses are often not effective in modifying the customer's behavior. Businesses therefore waste money and time providing offers to customers that do not want to shop and may not want to buy what the business is selling.

Likewise, customers are creatures of habit and many customers prefer to combine trips to businesses to efficiently conduct their transactions. Customers may receive offers for local businesses but these offers may not be directed to a product or process that the user is currently looking for. Customers are also busy and prefer convenient shopping experiences where their desires are anticipated compared to taking the inconvenient and risky chance that a business they visit is having a sale. Customers do not have time to search through all the available sales and offers to determine which of the businesses they typically visit has a current offer.

Financial institutions look to serve both business clients and customers. For example, financial institutions look to provide tailored marketing strategies so that businesses are effectively using marketing resources and customers are receiving useful information in a convenient manner.

Therefore, a need exists for a computer-implemented method and system that can identify when a customer is conducting a transaction and provide offers to the user based on predicted future actions of the user in order to target offers for goods and services that may be relevant to the customer.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Some embodiments of the present invention provide a computer-implemented method for providing offers based on a projected path triggered by a transaction at a point-of-transaction (“POT”) device that involves receiving data associated with a transaction at a point-of-transaction device, identifying a user associated with the data, predicting a projected path of the user based at least in part on the transaction at the point-of-transaction device, and providing the offer to the user based at least in part on the projected path. In some embodiments, the offers are provided to a user that has previously opted-in to accept offers through the program. In some embodiments, the projected path is predicted based on pattern recognition analysis of the user's financial transaction history. In other embodiments, the projected path is predicted based on a pattern recognition analysis of a population that shares some characteristics with the user. Certain embodiments will feature the additional steps of determining an offer to provide the user from a plurality of offers. The computer-implemented method may determine the offer based on the user's projected destination or the route the user will take to reach the destination.

Embodiments of the present invention provide a system for providing an offer based on a projected path triggered by a transaction at a point-of-transaction device. In an embodiment of the invention, the system includes a computing platform including a processor and a memory. The system also includes a user identification routine stored in the memory and executable by the processor. The user identification routine is configured to identify the user from data received from the point-of-transaction device. The system further includes a pattern recognition server stored in the memory and configured to receive data associated with the transaction and data associated with the transaction history of the user. The system further includes a pattern recognition routine stored in the memory and executable by the processor. The pattern recognition routine is configured to predict a projected path of the user based at least in part on the transaction. Further, the system includes an offer routine stored in the memory and executable by the processor. The offer routine is configured to provide the offer to the user.

Embodiments of the present invention further provide a computer program product comprising a non-transitory computer readable medium having computer executable program code embodied therein for providing an offer based on a projected path triggered by a transaction at a point-of-transaction device. In one embodiment, the computer-readable medium includes: a first set of codes for causing a computer to receive data associated with a transaction at a point-of-transaction device, the data comprising financial account information; a second set of codes for causing the computer to identify a user associated with the financial account information; a third set of codes for causing the computer to predict a projected path based at least in part on the transaction; and a fourth set of codes for causing the computer to provide an offer to the user based at least in part on the projected path.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for providing an offer based on a projected path triggered by a transaction at a point-of-transaction device, in accordance with some embodiments of the invention;

FIG. 2 is a depiction of an environment in which an offer based on a projected path triggered by a transaction at a point-of-transaction device is provided to a user, in accordance with some embodiments of the invention;

FIG. 3 is a block diagram of a pattern recognition server, in accordance with some embodiments of the invention;

FIG. 4 is a block diagram of a financial institution's banking system, in accordance with some embodiments of the invention;

FIGS. 5a and 5b are flow charts of a computer-implemented method for providing offers based on a projected path triggered by a transaction at a point-of-transaction device, in accordance with some embodiments of the invention;

FIG. 6 is a schematic of a map showing a computer-implemented method projecting a path for a user triggered by a transaction at a point-of-transaction device, in accordance with some embodiments of the invention; and

FIG. 7 is an example of a mobile device receiving an offer, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Computer-implemented methods, systems, apparatuses, and computer program products are described herein for providing offers to users along a projected path after receiving an indication of a transaction at a point of transaction device. In some embodiments, a user may opt-in to receive offers. After receiving an indication of a transaction at a point-of-transaction (POT) device, the computer-implemented method and system receives data regarding the transaction, identifies the user, and predicts a projected path for the user based on at least in part the transaction. A projected path is a predicted action of a user based on pattern recognition. For example, the computer-implemented method may analyze the user's transaction history and predict the user's next action based on consistent patterns of historical behavior. The computer-implemented method also provides an offer to the user based at least in part on the projected path, e.g., the computer-implemented method provides an offer associated with the predicted next action of the user. Such offers can be tailored to the user's needs and preferences by considering other available information, such as transactional data, biographical data, social network data, publicly available information, etc. Furthermore, offers may be provided to a user if the user is likely to use the offer. Based on the transactional data, biographical data, social network data, publicly available information, and the like, the system may determine the likelihood that a user will use the offer to make a purchase. In this way, the system may, in some embodiments, only provide the user with offers that he/she will likely use and not inundate the user with a multitude of offers that he/she will never use. Social network data may also be used to provide offers to the user's friends based on the user's projected path. In some embodiments, financial institutions are uniquely positioned to analyze historic patterns of behavior based on transaction data and thereby leverage data specific to financial institutions.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

The disclosure further discusses determination of a user's location. As discussed, user location can be determined by interaction of the user with a point-of-transaction device as discussed above. Location of the user could also be determined based on output from accelerometers, gyroscopes, earth magnetic field sensors, air-pressure sensors (altitude), etc.

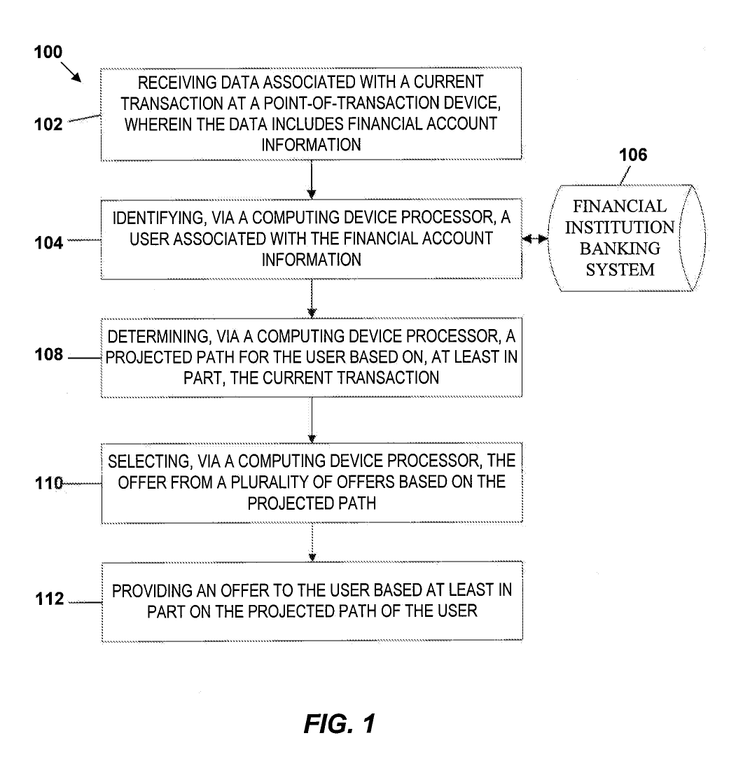

As illustrated in FIGS. 1-7, aspects of the present disclosure include computer-implemented methods, systems, and computer program products for providing offers to users associated with a projected path of the user. It will be appreciated that, although embodiments of the present invention are generally described in the context of advertisements for-profit businesses, other embodiments of the invention provide other types of offers for other types of organizations.

In one embodiment of the invention, a computer-implemented method of providing offers based on a projected path triggered by a point-of-transaction is provided. The computer-implemented method provides a service to bank customers by offering useful, and in some cases customized, offers to appropriate users. For example, a financial institution may receive data associated with a financial transaction at the point-of-transaction device, identify the user associated with the transaction, predict a projected path of the user based at least in part on the transaction at the point-of-transaction device, and provide an offer to the user based on the projected path. In some embodiments, the offer is customized for the user based on the user's previous transactions, the location, or other information available at the point-of-transaction device, from the user, or from the financial institution. Determination of offers, types of data received, and customization procedures using the computer-implemented method are discussed in more depth below with regard to FIGS. 1-7. The transactions at the point-of-transaction device will generally be discussed with regard to purchases though it should be understood that other types of transactions are possible. For example, returns, credit checks, balance inquiries (e.g., at an ATM, etc.), and transfers may all be used to project a path based on the point-of-transaction device.

FIG. 1 illustrates a general process flow of a computer-implemented method 100 for providing offers based on a projected path of the user triggered by a point-of-transaction, in accordance with an embodiment of the invention. In block 102, the computer-implemented method 100 receives data associated with a transaction at a point-of-transaction device, wherein the data includes financial account information. In an embodiment, the computer-implemented method 100 receives the data over a network, such as a transaction processing network or wireless network. The data may be encrypted for security. In some embodiments, the data includes financial account information. For example, the data may include the name and/or financial account number of a first party, e.g., a payor, to the transaction and an account number and/or financial account number of a second party, e.g., a payee. The data may further include the amount of the transaction, the time and date of the transaction, the location of the transaction, the category of the transaction, etc.

The point-of-transaction device is a device that facilitates the transaction between the user and the business or organization. In an embodiment, the point-of-transaction device is a cash register at a store. In another embodiment, the point-of-transaction device is mobile, such as a mobile ice cream truck. In some embodiments, the point-of-transaction device is associated with commerce but does not indicate that the user is making a purchase. For example, the user may be having a credit check run. Automated teller machines (ATMs) are also considered point-of-transaction devices that may trigger offers to businesses or organizations.

In block 104, the computer-implemented method 100 identifies, using a computing device processor, a user associated with the financial account information. In some embodiments, the computer-implemented method 100 identifies the user by identifying an account number associated with the transaction and then matching the account number with the user. In another embodiment, the user is identified from the data received from the transaction. In some embodiments, the user conducts a transaction using a mobile device, such as a mobile payment application on a phone, which provides the user's identity along with the transaction data. In other embodiments, however, the user is identified by the user's use of a credit card, debit card, rewards card, or personal check. In some embodiments, the computer-implemented method identifies the user in conjunction with a financial institution database 106. In other embodiments, the computer-implemented method 100 identifies the user from secondary sources such as social networking sites.

In block 108, the computer-implemented method 100 determines a projected path for the user. In some embodiment, the projected path is determined based on the point-of-transaction device. The computer-implemented method 100 may determine the business associated with the point-of-transaction device and predict the user's next action based on the identity of the business. For example, the computer-implemented method 100 may determine that the user is conducting a transaction at a coffee shop and, based on that information, predict that the user will be visiting the dry cleaners next. The computer-implemented method 100 may predict a projected path for the user based on an analysis of the user's transaction history. In further embodiments, the projected path is determined based on the data received from the point-of-transaction device. For example, the amount of the transaction, the time or date of the transaction, or the frequency of occurrence of the transaction might determine the predicted path of the user. In one example, the user may visit a restaurant often for lunch but rarely for dinner. When the user visits the restaurant for dinner, however, the user often goes to a movie after dinner. The computer-implemented method 100 may identify this consistent pattern of behavior and provide an offer to the user related to movies when the user visits the restaurant in the evening but not at lunch. In some embodiments, multiple transactions are used to refine the predicted path of the user.

Turning now to block 110, the computer-implemented method 100 determines an offer for the user from a plurality of offers. In an exemplary embodiment of the invention, the offer is selected based on the projected path of the user. In addition, in some embodiments, the offer provided to the user may be one that the system determined to be likely used by the user. This is based on the transactional data, biographical data, social network data, publicly available information, and the like, of the user. In one embodiment, the computer-implemented method provides an offer associated with the business or organization that the user is predicted to visit next. For example, if the user is predicted to visit a dry cleaner after conducting a transaction at a coffee shop, the user may receive a coupon to the dry cleaner to provide further incentive for the user to visit the dry cleaner. In another embodiment, the computer-implemented method 100 provides an offer to a business located on the way to the predicted destination or near the predicted destination. The computer-implemented method 100 may predict that the user will visit the dry cleaner next but provide an advertisement for a drugstore next door to the dry cleaners. In a still further embodiment, the computer-implemented method 100 provides an offer to a competitor of the predicted destination. If the computer-implemented method 100 predicts that the user will visit the dry cleaner based on a purchase at a coffee shop, the computer-implemented method may send the user a coupon for a different dry cleaner. In still other embodiments, offers are provided to the user's “friends” on a social network site based on the user's projected path.

In one embodiment of the invention, the offer is an advertisement. For example, the offer may be an advertisement for a business or service. In other embodiments, the offer may include a coupon, a solicitation, a request for volunteer service, or an offer to visit a tourist site, etc. The offer may be customized for the user with data from the user's financial accounts. The offer may be in visual (e.g., a written advertisement or a picture, etc.) or audible (e.g., a recording, a jingle, etc.) format.

In block 112, once the computer-implemented method 100 determines the offer to provide to the user, the computer-implemented method 100 provides the offer to the user. In some embodiments, the computer-implemented method 100 determines contact information for the user and contacts the user using the contact information. For example, the user may have provided a phone number, an email address, a social networking ID, instant messaging ID, or other contact means. The computer-implemented method may send the user a text or SMS message providing the user details of the offer. In another example, the computer-implemented method 100 provides the offer to the user via an email, such as an email with web-enabled hyperlinks embedded therein, so that the user can gather more information regarding the offer. In still further examples, the offer may be provided to the user via a phone call, such as an automatically generated phone call, a pre-recorded phone call, or a live phone call from a representative of the organization associated with the offer. The offers could be sent to via user's TV, in-car video/audio, or the like. For example, offers and navigational directions could be sent to the navigation system on a car.

As will be discussed, the computer-implemented method 100 may have a variety of supplemental steps and accomplish the steps in a variety of ways. Further, the steps do not need to be performed in the order discussed herein. The examples disclosed herein are not intended to be limiting to the various ways in which the user or predicted path may be identified, or the ways the offer may be provided to the user.

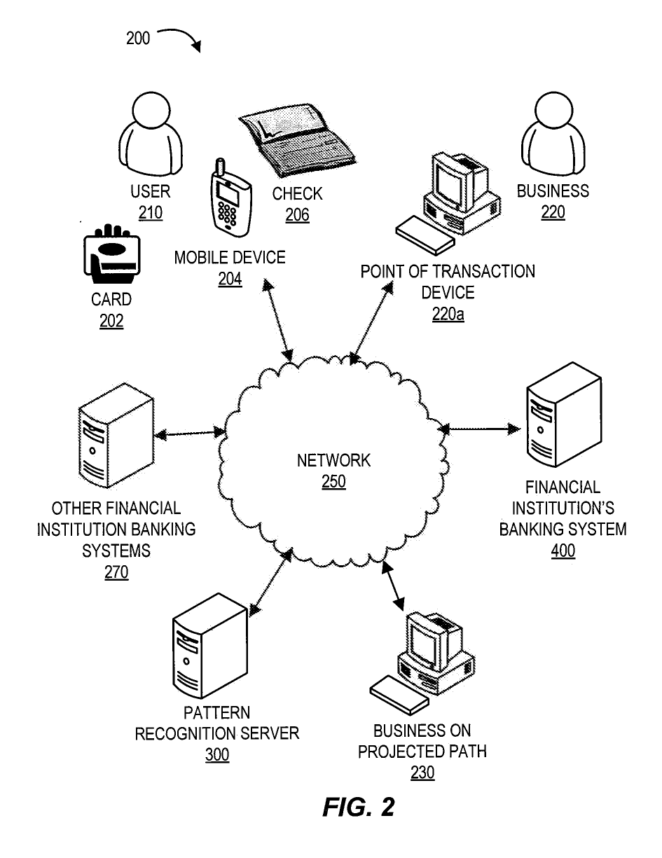

Referring to FIG. 2, a block diagram illustrating an environment 200 in which a user 210 is provided an offer based on a projected path triggered by a transaction at a point-of-transaction device 220 is provided in accordance with an embodiment of the invention. As denoted earlier, the user 210 may conduct the transaction using a variety of methods of payment. For example, the user may pay with a card 202, such as a credit card, debit card, or rewards card. In some embodiments, the user conducts the transaction with a mobile device 204 or a personal check 206. In an embodiment, the personal check 206 is immediately scanned and entered into the system so that the computer-implemented method is alerted to the transaction occurring as the user conducts the transaction.

When the user conducts the transaction, the point-of-transaction device 220 or the user's mobile device 204 transmits data to the financial institution's banking system 400. In an embodiment, the point-of-transaction device 220 or the user's mobile device 204 transmits the data over a network 250. For example, the data may be transmitted over wired networks, wireless networks, the Internet, Near Field Communication (NFC) networks, Bluetooth™ networks, or the like.

The data transmit over the network 250 to the financial institution's banking system 400, where the identity of the user 210, a business 230 on a projected path, and/or the offer are determined. In some embodiments, the user 210 is identified in coordination with other financial institution banking systems 240, with the user 210 or the user's mobile device 204, or with the point-of-transaction device 220. In an embodiment, the location of the user and//or the projected path of the user is determined using a pattern recognition server 300. The pattern recognition server 300 may be integral with the financial institution's banking system 400 or may be operated separately from the financial institution's banking system 400.

In some embodiments, the financial institution's banking system 400 coordinates with other businesses 230. For example, the financial institution banking system 400 may communicate with businesses 230 on the projected path of the user 210. The banking system 400 may determine that a business 230 is likely to be visited by the user next based on pattern recognition from the user's financial transactions. The banking system 400 can communicate with the business 230 to prompt the business to make an offer to the user 210. In another embodiment, the banking system 400 contacts competitors of the business 230 and prompts the competitors to make an offer to the user. For example, the banking system 400 may determine that the user 210 will likely visit a restaurant after shopping at a particular store. The banking system 400 may solicit businesses around the store to determine which business would like to provide an offer to the user 210.

In the environment 200, the user receives the offer over the network 250 via the user's mobile device 204 or via the point-of-transaction device 220. The user does not need to conduct the transaction using the mobile device 204 in order to receive the offer via the mobile device 204. For example, the user may pay with a credit card and then receive a text message on the user's phone indicating an offer for a nearby business. In other examples, the user 210 receives the offer via an email, via a phone call, or via a social networking contact. The user 210 may also receive the offer as a printed offer on the receipt generated at the point-of-transaction device 220 or may be provided the offer by the business 220a, such as by a person working the cash register who is prompted to provide the offer by the computer-implemented method 100.

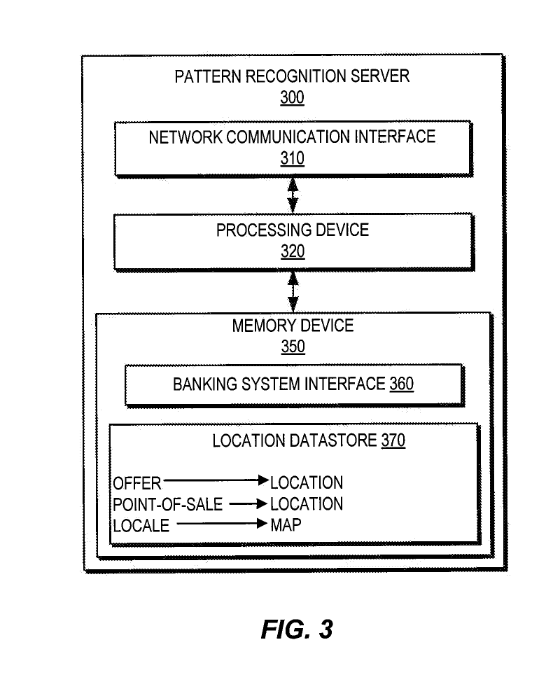

FIG. 3 provides a block diagram illustrating a pattern recognition server 300, in accordance with an embodiment of the invention. In one embodiment of the invention, the pattern recognition server 300 is operated by a second entity that is a different or separate entity from the first entity (e.g., the financial institution) that, in one embodiment of the invention, implements the banking system 400. In one embodiment, the pattern recognition server 300 could be part of the banking system 400. As illustrated in FIG. 3, the pattern recognition server 300 generally includes, but is not limited to, a network communication interface 310, a processing device 320, and a memory device 350. The processing device 320 is operatively coupled to the network communication interface 310 and the memory device 350. In one embodiment of the pattern recognition server 300, the memory device 350 stores, but is not limited to, a path determination module 360 and a location database 370. The location database 370 stores data including, but not limited to, the location of businesses, the location of ATMs, the locations associated with offers, etc. In one embodiment of the invention, both the path determination module 360 and the location database 370 associate with applications having computer-executable program code that instructs the processing device 320 to operate the network communication interface 310 to perform certain communication functions involving the location database 370 described herein. In one embodiment, the computer-executable program code of an application associated with the location database 370 may also instruct the processing device 320 to perform certain logic, data processing, and data storing functions of the application associated with the location database 370 described herein.

The network communication interface 310 is a communication interface having one or more communication devices configured to communicate with one or more other devices on the network 250. The processing device 320 is configured to use the network communication interface 310 to receive information from and/or provide information and commands to a mobile device 204, other financial institution banking systems 240, the pattern recognition server 300, the banking system 400, and/or other devices via the network 250. In an embodiment, the network communication interface 310 communicates with the financial accounts of the user in the banking system 400 in coordination with the path determination module 360. In some embodiments, the processing device 320 also uses the network communication interface 310 to access other devices on the network 250, such as one or more web servers of one or more third-party data providers. In some embodiments, one or more of the devices described herein may be operated by a second entity so that the third-party controls the various functions involving the proximity database 300. For example, in one embodiment of the invention, although the banking system 400 is operated by a first entity (e.g., a financial institution), a second entity operates the path determination server 300 that predicts the user's next action and projects a path based on the predicted action.

As described above, the processing device 320 is configured to use the network communication interface 310 to gather data from the various data sources. The processing device 320 stores the data that it receives in the memory device 250. In this regard, in one embodiment of the invention, the memory device 250 includes datastores that include, for example: (1) location information for offers, (2) location information for point-of-transaction devices; (3) information regarding modes of transportation, such as maps, train schedules, or traffic patterns; and/or (4) historic transaction data for users. In an embodiment, the datastores may be added to independently of the banking system 400. For example, businesses wanting to attract customers may provide offers and their location to a third-party manager, which then adds the information to the memory device 250. In another embodiment, the memory device stores historic transaction data for the user received from the financial institution's banking system 400 for use in predicting future actions of the user.

In some embodiments of the invention, the pattern recognition server 300 is configured to be controlled and managed by one or more third-party data providers (not shown in FIG. 2) over the network 250. In other embodiments, the pattern recognition server 300 is configured to be controlled and managed over the network 250 by the same entity that maintains the financial institution's banking system. In other embodiments, the pattern recognition server 300 is configured to be controlled and managed over the network 250 by the financial institution conducting the transaction. For example, the transaction may be conducted through credit card networks rather than brick and mortar bank networks. In still other embodiments, the pattern recognition server 300 is a part of the banking system 400.

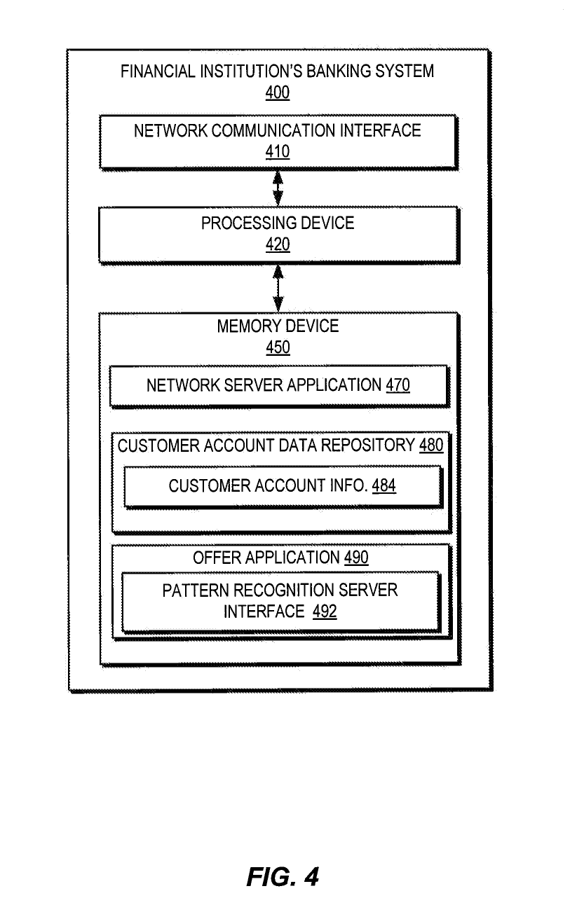

FIG. 4 provides a block diagram illustrating the banking system 400 in greater detail, in accordance with embodiments of the invention. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, a user account data repository 480, which includes user account information 484, an offer application 490, which includes a pattern recognition server interface 692, and other computer-executable instructions or other data. The computer-executable program code of the network server application 470 or the offer application 490 may instruct the processing device 420 to perform certain logic, data-processing, and data-storing functions of the banking system 400 described herein, as well as communication functions of the banking system 400.

As used herein, a “communication interface” generally includes a modem, server, transceiver, and/or other device for communicating with other devices on a network, and/or a user interface for communicating with one or more users. Referring again to FIG. 2, the network communication interface 410 is a communication interface having one or more communication devices configured to communicate with one or more other devices on the network 250, such as the mobile device 204, the banking system 400, the other financial institution banking systems 240, and the pattern recognition server 300. The processing device 420 is configured to use the network communication interface 410 to transmit and/or receive data and/or commands to and/or from the other devices connected to the network 250.

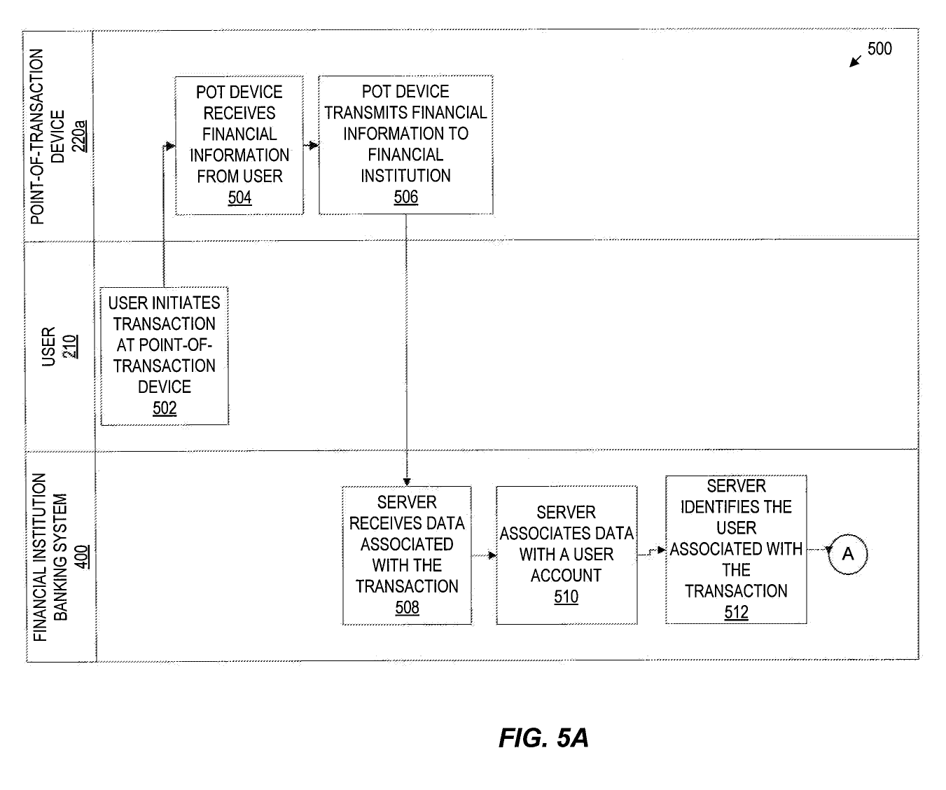

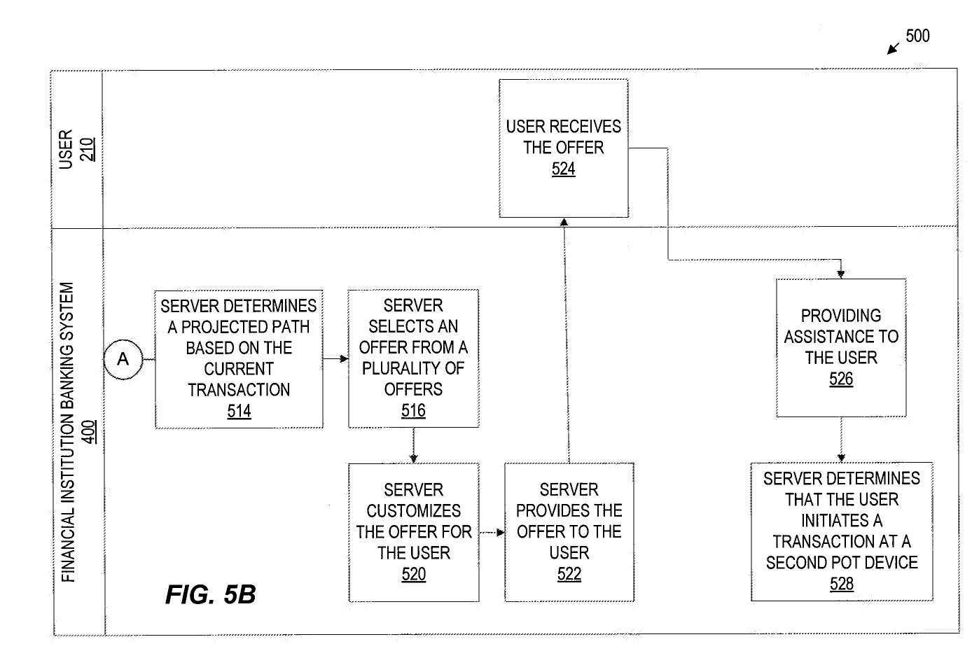

FIGS. 5A and 5B provide a modified flow chart showing actions taken by the user, the point-of-transaction device, and the financial institution server in a computer-implemented method 500 to provide an offer based on a projected path triggered by a transaction at a point-of-transaction device, in accordance with an embodiment of the invention. While the steps are depicted as performed by one of the parties listed in the flow chart, the steps do not need to be performed by that exact party. For example, the point-of-transaction device is depicted as providing the data to the financial institution server in block 504; however, the user may do this instead of or in addition to the point-of-transaction device. The user may provide the data via the user's mobile device.

In block 502, the user, whom in some embodiments has opted-in to receive offers via the program, initiates a transaction at a point-of-transaction device. In an embodiment, the user purchases something at a business by using a credit card, using a mobile payment application on a mobile phone, or by paying with a personal check. In other embodiments, the user returns a purchase and provides a card to receive a refund, conducts an action at an ATM, or provides the user's identity to a business. For example, the user may check in at a gym using a network-enabled ID. The computer-implemented method 500 determines that the user is at the gym, determines based on pattern recognition that the user typically makes a purchase at a grocery after the gym, and provides an offer to a nearby grocery.

In block 504, the point-of-transaction device 220a receives financial information from the user 210. The point-of-transaction device 220a may receive the user's account information including with the information used to complete the transaction. In an embodiment, the user 210 swipes a card, such as a debit card, through a credit card reader to provide the information to the point-of-transaction device 220a. In other embodiments, the user activates a mobile payment application on a mobile device, writes a personal check, or inserts a card into an ATM reader. The point-of-transaction device 220a may receive the financial information in an encrypted format or over a secure network. In an embodiment, the point-of-transaction device requests authentication of the user's identity when receiving the financial information.

In block 506, the point-of-transaction device 220a transmits data to the financial institution's banking system 400. In an embodiment, the data comprises financial institution account data for the user, for the payee, or for both. The financial institution account data may include the user's account number, the payee's account number, or proxies for both. As discussed, instead of or in addition to the point-of-transaction device, the user may transmit data to the financial institution server, such as via a mobile computing application on a mobile device. The point-of-transaction device or user transmits the data over the network. In an embodiment, the network and/or the data are encrypted. The data may include information in addition to the financial institution account data, such as the amount of the transaction, the location of the transaction, and/or the time and date of the transaction.

Turning to block 508, the financial institution's banking system 400 receives the data from the point-of-transaction device, including the financial account data. In one embodiment, the financial institution's banking system 400 receives the data over the network 250. In some embodiments, the financial institution's banking system 400 decrypts the data. In an embodiment, the server receives the data from the point-of-transaction device and supplements the data with information from secondary sources. For example, the data may be supplemented with the time of the transaction, with the method that the transaction is being conducted (e.g., credit card, mobile payment device, etc.), or with the category of the business where the transaction is occurring (e.g., a grocery store, a restaurant, a clothing store, etc.).

In block 510, in order to identify the user, the computer-implemented method 500 associates the financial account data with a user account. In an embodiment, the financial institution's banking system 400 interacts with a financial institution database to look up the account number and find the user name associated with the account number. In some embodiments, the user may be identified based on the information the user provided upon opting-in to the program to receive offers.

In block 512, the computer-implemented method 500 identifies the user from the user account. In an embodiment, the server also identifies contact information for the user. For example, the server may identify a phone number, email address, social networking ID, instant messaging ID, or other means to contact an individual. In one embodiment, the contact information is provided by the user, such as when the user sets up an account with the financial institution. In another embodiment, however, the financial institution's banking system 400 identifies the contact information from secondary information, such as credit reports, the Internet, or other publicly available information.

Turning to block 514, the computer-implemented method 500 determines a projected path based, at least in part, on the current transaction. In an embodiment, the server identifies the transaction, evaluates the user's transaction history, and predicts the user's next action based on the combination of the current transaction and what the user has done previously after conducting a similar transaction. For example, the computer-implemented method 500 may identify the transaction from the data received from the point-of-transaction device, e.g., the point-of-transaction device transmits the business's name or location to the financial institution when authorizing the transaction. In another embodiment, the computer-implemented method 500 identifies the transaction based on the user. For example, the user's mobile device may transmit the user's location, which is then used to identify the business where the user is conducting the current transaction.

In a still further embodiment, the amount of transaction is used to identify the transaction. For example, the user may spend the same amount of money each month at a business, paying by personal check. While the business name may not be transmitted to the financial institution when the check is authorized, the amount of the transaction may be sufficient to identify a historic pattern of behavior. The server may recognize that user visits a specific store consistently after spending X amount of money at a first store. The server does not need to recognize the identity of the store if the amount of money is distinguishing.

In some embodiments, the time and/or date of the transaction is used to identify the transaction. Users may have specific patterns of behavior but vary the location or amount of the transaction. For example, a user may visit a different restaurant every Saturday evening and then go to a movie. In an embodiment, the computer-implemented method 500 recognizes that the user is conducting a transaction at a restaurant (point-of-transaction) and provides an offer associated with a nearby movie theater, regardless of whether the user is at a restaurant that the user has been at previously.

The computer-implemented method 500 analyzes the user's transaction history to determine historic patterns of behavior related to the transaction. In an embodiment, the computer-implemented method recognizes patterns in the transaction history and predicts a path for the user based on the pattern recognition. For example, the computer-implemented method may identify that the user is conducting a transaction at a specific coffee shop. The computer-implemented method analyzes the user's transaction history and determines that a given percentage of the time (e.g., 90% of the time) after conducting a transaction at that specific coffee shop, the user visits a specific dry cleaner. It should be understood that the consistency of the relationship may vary so long as a consistent pattern of behavior can be recognized. For example, the user may visit the dry cleaner 50% of the time and still receive an offer related to dry cleaners or the user may visit the dry cleaner more often than the user visits any other store after making a purchase at the coffee shop and still receive an offer to dry cleaners. The pattern of behavior may be separated in time. For example, the computer-implemented method may determine that the user deposits a paycheck at an ATM on Friday evenings and then makes a large purchase at a grocery store on Saturday mornings. The computer-implemented method can, based on this historic pattern of behavior, project a path for the user on Saturday morning such that the user will receive an offer for the grocery store or another offer in the vicinity of the grocery store.

It should also be understood that frequency or percentage of visits is not the only manner in which a historic pattern of behavior may be analyzed. The computer-implemented method may use any type of predictive analysis such as regression models (e.g., linear regression, multivariate regression, logistic regression, etc.), classification and regression trees, Bayesian analysis, data mining tools, time series models, etc. to recognize patterns in the user's transaction data and project a path for the user based on the pattern recognition.

In an embodiment, the computer-implemented method predicts the user's actions based on historic patterns of behavior for populations of individuals. For example, the user's transaction history may have an insufficient number of relevant transactions to predict the user's next action with any power. Instead, the computer-implemented method analyzes the behavior of a group of individuals within a population, such as all individuals that have conducted a similar transaction. For example, if a user has never shopped at a specific store the computer-implemented method may have insufficient information to determine a projected path. The computer-implemented method, however, may analyze the transaction histories of all other customers that have conducted a transaction at that specific store previously or within a previous time period, e.g., one year, and determine a projected path of behavior based on the population. If a gas station is immediately next door to the store and the majority of customers shopping at the store also visit the gas station, then the computer-implemented method may provide an offer to the user regarding the gas station.

The computer-implemented method predicts a projected path for the user based on the identification of the current transaction and the analysis of the historic patterns of behavior. In some embodiments, the projected path will be a transaction at another business. In other embodiments, however, the projected path is an online transaction, such as a funds transfer. In further embodiments, the projected path is any sort of transaction that may be detected by the financial institution, such as a deposit at an ATM, a charitable contribution, or a credit check.

The projected path may be a specific destination, such as a store that is typically visited. In another embodiment, the projected path is a specific type of transaction, such as a purchase at a grocery store. In a still further embodiment, the projected path is a route, such as a known destination anytime the user fills the car up with gas in a specific town. For example, if the user often fills the car up with gas at a specific gas station on the way to a distant town, the computer-implemented method may identify a transaction at that gas station, predict a projected path to the distant town for the user, and provide offers related to businesses in that town.

In some embodiments, the server determines at least one previous transaction of the user. In some embodiments, the computer-implemented method uses more than one transaction to predict a future action of the user. In these embodiments, the computer-implemented method determines, via the computing device processor, at least one previous transaction of the user. For example, the user may be conducting a transaction at a first store using a debit card linked to an account at the financial institution. The computer-implemented method may recognize that the user initiated this transaction and then determine, based on review of the user's financial transaction history, that the user conducted a transaction at a second store an hour previously using a credit card associated with a different account at the financial institution. The computer-implemented method can then use both of the transactions to predict the user's next action based on pattern recognition. The previous transaction may be from the user's accounts with the financial institution or with a financial account of the user at another financial institution.

The previous transaction may be limited based on time or location. For example, the computer-implemented method may discount any transactions that occurred more than a pre-determined period of time, such as four hours, previously. Two transactions occurring so far apart in time may not be linked such that they provide any additional information to the system with regards to predictable patterns of behavior by the user. In some embodiments, however, actions that occur far apart in time may still assist the computer-implemented method in determining predictable patterns of behavior and predicting a projected path for the user. The computer-implemented method may recognize a particularly strong pattern of behavior, even though separated by significant time, and project a path based on that pattern. Similarly, transactions conducted far apart geographically may still inform the projected path of the user based on predictive modeling. For example, a user may have a consistent pattern of behavior where the user fills his car up with gas, drives five hours to visit family, again fills the car up with gas once reaching his destination, and often goes to dinner at a specific restaurant the first night in town with his family. The computer-implemented method can analyze the first transaction at the gas station and the second transaction at the second gas station, which by themselves would not indicate that the user will soon be visiting a restaurant, but when analyzed together indicate a high probability that the user will be visiting the specific restaurant that evening.

In block 516, the computer-implemented method determines which offer from a plurality of offers is provided to the user. The offer may be determined in a variety of ways. In an embodiment, the offer is determined based on the destination of the projected path. For example, if the business that the user is predicted to visit next has an offer in the location datastore, the user may be provided that offer. In some embodiments, competitors of the business that the user is predicted to visit next will have an offer in the location datastore, and these offers can be provided to the user. The competitors may be identified based on category and/or distance. For example, the user may be predicted to visit a coffee shop next. In some embodiments, the offers may be determined based on the likelihood the user will accept the offer. In this way, the user may not be inundated with several offers from the system that the user may never utilize to make a purchase. The computer-implemented method provides an offer related to a new coffee shop that just opened up and is competing with the coffee shop that the user usually visits. In a still further embodiment, the offer is determined based on the route that the user will likely take to reach the user's destination. For example, if pattern recognition of the user's transaction history indicates that the user will likely visit a specific store at a mall, an offer may be determined such that the user drives by the business associated with the offer on the way to the mall. In a still further embodiment, the offer is determined based on proximity to the destination. For example, if the user is predicted to visit a store at a mall, the offer may be determined such that it relates to another store in the same mall.

In further embodiments, the user's previous acceptance of offers is used to determine which offer from a plurality of offers should be provided to the user. The computer-implemented method is able to determine whether after receiving an offer for a business, the user goes to that business and conducts a transaction. In this manner, the user response to offers can be used to provide more effective targeting of offers. For example, if a user rarely goes to a donut shop after receiving an offer for a donut shop based on the user's transaction history, the user may be predisposed to not receive offers to donut shops when predicting the user's next action. In further embodiments, the likelihood that a user will be interested in an offer, i.e., conduct a transaction at a business associated with the offer, influences the determination of the user's projected path. In the donut shop example, the lack of response to offers to donut shops even if other transaction characteristics indicate that the user would likely go to one may be considered when determining the user's projected path. The user may typically go to the donut shop without thinking about the destination in advance. If, however, the user receives an offer to a donut shop the user may think about food and decide to eat somewhere healthier. Whether a user is likely to accept an offer or likely to not accept an offer can both be used to more accurately target offers to individuals that might be interested in the goods and services being provided.

In some embodiments, the user's social network is used to determine which offer from a plurality of offers will be presented to the user. In one embodiment, the user's connections on social networking sites are identified and used to select an offer from a plurality of offers. For example, if the user is predicted to go to a shopping mall after conducting removing cash from an ATM and five offers from stores within the shopping mall are available, the computer-implemented method may identify the user's connections on a social networking site, determine which of the five stores the connections shop at most frequently or most recently, and provide an offer from that store to the user. In another embodiment, the offers are also provided to the members of the user's social network. For example, if a user is conducting a transaction at a store and an offer is determined for that user at a predicted next stop of the user, the user's connections on a social networking site may also be presented with the offer. In a still further embodiment, the user's connections are presented the offer and all of the recipients are informed that their connection(s) have also been made the offer. In this manner, the computer-implemented method encourages social activity around shopping while still maintaining convenience for the original user. It is also understood that the user could opt to forward offers he/she receives to third parties via email, text, SMS, sharing on social media, etc.

In block 520, the computer-implemented method customizes the offer for the user. In one embodiment, the computer-implemented method supplements the offer with user-specific data. For example, the computer-implemented method may supplement the offer with the user rewards number or membership card. If a user receives an offer to shop at a grocery store, the user may receive a MMS text message that includes a scannable image of the user's rewards card for the grocery store. Then, even if the user does not have the rewards card with them, the user is able to go to the grocery store, make a purchase, and use the rewards card to purchase the item. In another embodiment, the offer is customized by presenting information to the user regarding the offer. For example, if the offer is for a sale at a nearby business the computer-implemented method may supplement the offer with the total amount of money spent at the business by the user, the last transaction at the business, the total number of transactions conducted at the business by the user, or other information.

In block 522, the server provides the offer to the user. As discussed, the server may provide the offer to the user in a variety of ways. In an embodiment, the server provides the offer to the user by contacting the user through the user's mobile device. For example, the user may receive a text message (e.g., a short message service, SMS, or a multimedia messaging service, MMS, etc.) on the user's mobile device alerting them to the offer. In another embodiment, the server provides a pre-recorded, automated, or live phone call to the user providing the offer. In a still further embodiment, the server provides an email, an instant message, a contact via a social networking site, or other contact means to provide the offer to the user. In some embodiments, the current point-of-transaction is configured or prompted to provide the offer to the user. For example, the offer may be printed on the receipt received at the first point-of-transaction device.

In an embodiment, the offers are time limited to provide an incentive to the user to visit the business. For example, the offer may provide a coupon worth a certain percent off of a purchase if the purchase is made within the next hour. The offer also informs the user that the business is located within a ten minute drive of the user's location, and in some embodiments may offer to provide directions to the business. In this manner, the computer-implemented method makes shopping easy and convenient while providing businesses with targeted, effective marketing strategies.

In block 524, the user receives the offer from the server. In an embodiment, the user receives a notification on the user's mobile device that a text message, email, instant message, or social networking message has been received. In another embodiment, the user's mobile phone informs the user that the user is receiving a phone call. In a still further embodiment, the point-of-transaction device provides a receipt or notice providing the offer. The offer may be verbal or written. In an embodiment, the offer is a pre-recorded voice. In another embodiment, the offer is a written solicitation. In an embodiment (not shown), the user requests assistance regarding the offer. For example, the user may request directions to the business associated with the offer. In an embodiment, this server is provided for a fee. The user may by default agree to pay the fee, may pay in advance for the service, such as per assistance or a flat fee, or may agree to pay the fee at the time of the offer. For example, the user may agree to pay the fee at the time of the offer and pay the fee at the current point-of-transaction device.

Turning now to block 528, the server provides assistance to the user. In an embodiment, the server provides directions to the user. For example, the server may send the user an email with turn by turn directions, such as in a web-based mapping application. In some embodiments, the server provides the destination to the user's mobile device and triggers a mapping application on the user's mobile device to provide directions to the user. In another example, the server tracks the user's movement based on a positioning device, such as a GPS device, in the user's mobile device and sends the user an email with instructions on how to reach the business associated with the offer. In a still further embodiment, the user may receive a phone call from a recorded or live person providing assistance with respect to the offer. For example, the user may be able to pay a fee and receive an immediate phone call from a person, wherein the person is prepared to stay on the line and provide directions to the user until the user reaches the business. In an embodiment, the person providing the assistance is a third party contractor. In another embodiment, the person providing the assistance is affiliated with the business providing the offer.

In block 530, the server determines that the user is initiating a transaction at the second point-of-transaction device. The user may have been motivated to visit the second point-of-transaction device by the first offer or the user may have visited the second point-of-transaction device independently. The computer-implemented method may store the user's actions in the pattern recognition server so that future offers may be more accurately tailored to the user's preferences. In block 530, the computer-implemented method is able to begin the process again by receiving financial account information, projecting a path based on pattern recognition, and providing the offer to the user.

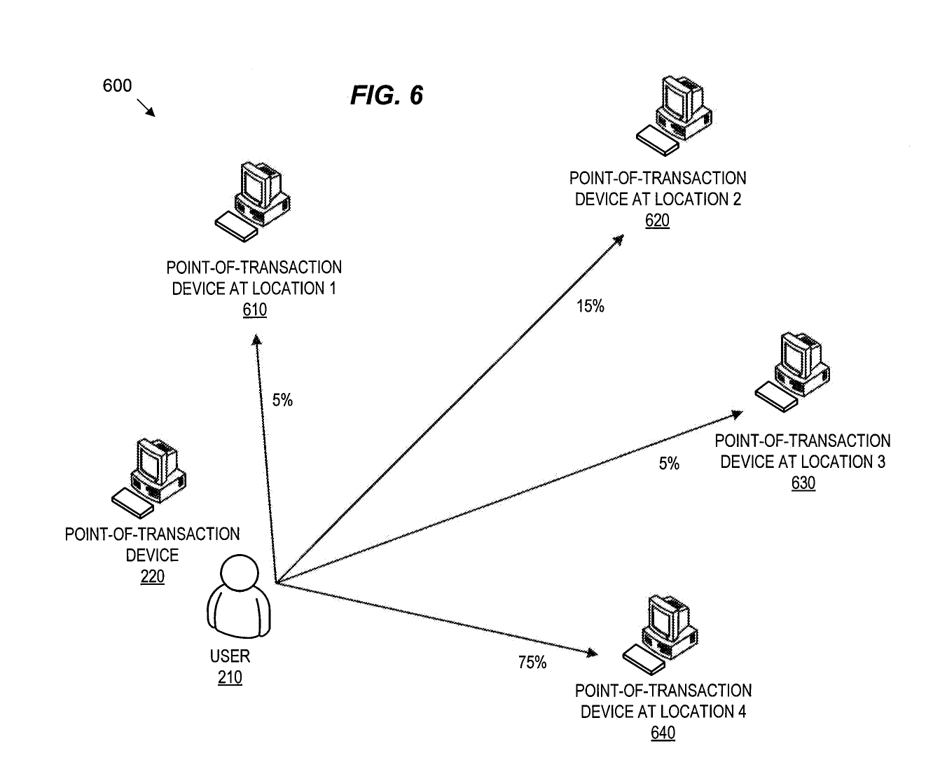

Turning now to FIG. 6, a schematic diagram 600 of a user in an environment is provided, wherein the computer-implemented method projects a path for the user triggered by a transaction at a point-of-transaction device. In an embodiment, the user 210 is conducting a transaction at a point-of-transaction device 220. The computer-implemented method determines that the customer is initiating a transaction and receives data from the point-of-transaction device 220, including account information. The computer-implemented method identifies the point-of-transaction device 220 from the information received and analyzes the transaction history of the user 210. In an embodiment, the computer-implemented method determines that previously the user 210 conducted transactions at four point-of-transaction devices 610, 620, 630, 640 after conducting a transaction at the current point-of-transaction device 220. The computer-implemented method may determine the frequency with which the user visits each of the four point-of-transaction devices to predict a projected path for the user. In this example, the user visited point-of-transaction device 610 5% of the time after conducting a transaction at point-of-transaction device 220, the user visited point-of-transaction device 620 15% of the time after conducting a transaction at point-of-transaction device 220, the user visited point-of-transaction device 630 5% of the time after conducting a transaction at point-of-transaction device 220, and the user visited point-of-transaction device 640 75% of the time after conducting a transaction at point-of-transaction device 220. The computer-implemented method thus recognizes a consistent pattern of behavior by the user to visit the point-of-transaction device 220 and then visit the point-of-transaction device 640 based on pattern recognition in the user's transaction history. The computer-implemented method may then provide an offer to the user based, at least in part, on the projected path of the user. For example, the computer-implemented method may send the user a text message associated with the point-of-transaction device 640.

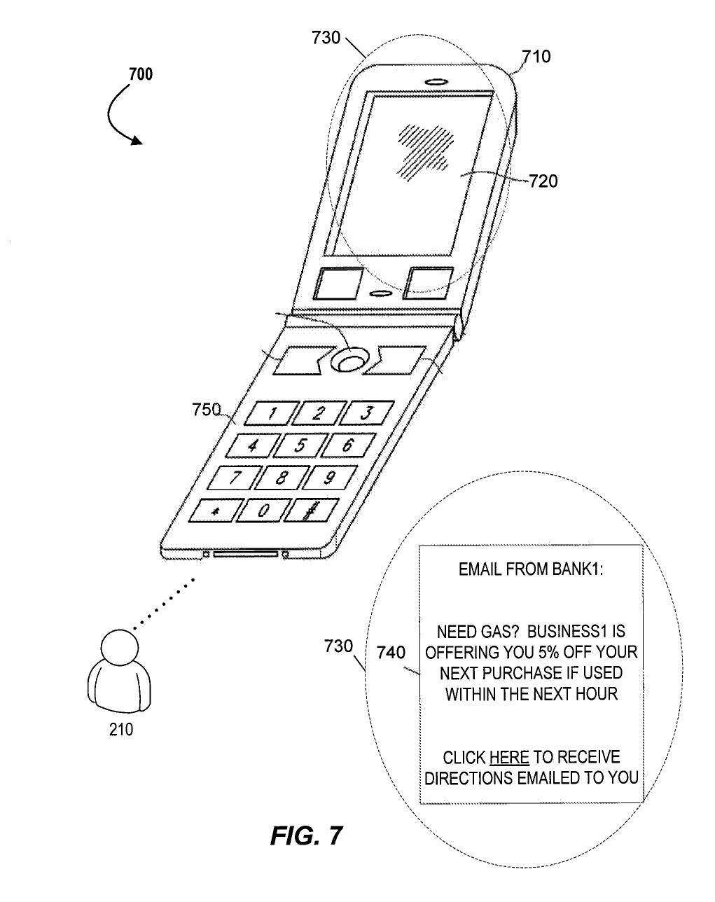

In FIG. 7, an example of a method of providing the offer to the user is presented, in accordance with an embodiment of the invention. In this example, the user 210 receives an email 740 on the user's mobile device 710. The email is displayed on the screen 720 in response to the user conducting a transaction at a point-of-transaction device. Advantageously, the message is able to immediately provide an offer to a user, wherein the offer is targeted to a predicted action of the user, and also offer assistance to the user. In an embodiment, the user responds to the offer using an input device 750, such as a keypad or touch-sensitive screen.

The above description refers to a centralized server as the computing device processor and describes the server as performing the computer-implemented method. It should be understood, however, that the computing device processor can be a mobile device of the user and the processor associated with the mobile device can perform the computer-implemented method. In one embodiment, the data processing associated with the computer-implemented method can be performed on the mobile device and the data can be stored on remote servers. For example, the mobile device may communicate with the remote servers to receive data associated with the user's transaction history and offers and then perform the computer-implemented method based on the data received from the remote servers. In another embodiment, the data is stored on the mobile device. For example, the user's transaction history and offers may be intermittently or regularly uploaded to a secure database on the user's mobile device and accessed when the computer-implemented method is activated on the user's mobile device. In this example, the computer-implemented method is capable of operating when the user does not have access to wireless networks, such as in areas of low coverage or where buildings prevent coverage.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wired, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments of the invention, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment of the invention, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment of the invention, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method of providing an offer based on a projected path triggered by a transaction at a point-of-transaction device, the method comprising:
receiving data associated with a transaction at a point-of-transaction device, wherein the data includes financial account information;
identifying, via a computing device processor, a user associated with the financial account information;
predicting, via a computing device processor, a projected path of the user based at least in part on the transaction at the point-of-transaction device; and
providing an offer to the user based at least in part on the projected path of the user.

2. The computer-implemented method of claim 1, further comprising:
determining, via a computing device processor, an identity of the business of the point-of-transaction device; and
predicting the projected path based on the identity of the business.

3. The computer-implemented method of claim 2, wherein the projected path is predicted based on a historic pattern of transactions by the user after the user has patronized the identified business.

4. The computer-implemented method of claim 2, wherein the projected path is predicted based on historic pattern of transactions by customers of a financial institution after the customers have patronized the identified business.

5. The computer-implemented method of claim 4, wherein the customers are selected based on similarity to the user.

6. The computer-implemented method of claim 1, wherein the projected path is predicted based on a historic pattern of transactions after the user conducted a previous transaction at substantially the same time.

7. The computer-implemented method of claim 1, further comprising customizing, via a computing device processor, the offer based on at least one previous financial transaction of the user.

8. The computer-implemented method of claim 1, wherein the offer is selected from a plurality of offers based at least in part on proximity to a business on the projected path.

9. The computer-implemented method of claim 1, wherein the offer is selected from a plurality of offers to provide an offer from a competitor of a business on the projected path.

10. The computer-implemented method of claim 1, wherein the offer is selected from a plurality of offers based at least in part on previous acceptance of related offers by the user.

11. The computer-implemented method of claim 1, wherein the offer is selected from a plurality of offers based at least in part on a social network of the user.

12. The computer-implemented method of claim 1, wherein identifying the user associated with the financial account information further comprises:
identifying, via a computing device processor, a financial account associated with the financial account information; and
determining, via a computing device processor, the user associated with the financial account.

13. The computer-implemented method of claim 12, further comprising determining, via a computing device processor, contact information for the user, wherein the contact information is selected from the group consisting of a telephone number, an email address, and a social networking ID.

14. A system for providing an offer based on a projected path triggered by a transaction at a point-of-transaction device, the system comprising:
a computing platform including a processor and a memory;
a user identification routine stored in the memory, executable by the processor and configured to identify an identity of a user associated with a transaction at a point-of-transaction device;
a pattern recognition server stored in the memory and configured to receive data associated with the transaction and data associated with transaction history of the user;
a pattern recognition routine stored in the memory, executable by the processor and configured to predict a projected path for the user based at least in part on the transaction; and
an offer routine stored in the memory, executable by the processor and configured to provide the offer to the user.

15. The system of claim 14, wherein the pattern recognition routine is configured to identify the transaction, analyze the transaction history of the user, and predict the projected path of the user based on the transaction and the transaction history of the user.

16. The system of claim 14, wherein the projected path is predicted based on the transaction history of a population of customers of a financial institution.

17. The system of claim 16, wherein the population of customers is defined as all customers that have conducted a transaction at the point-of-transaction device within a predetermined time period.

18. The system of claim 16, wherein the population of customers is defined based on similarity to the user.

19. The system of claim 14, wherein the offer is provided by sending a message to the user, wherein the message is selected from the group consisting of an email, a text message, a phone message, an instant messaging message, and a social networking message.

20. The system of claim 14, wherein the projected path is predicted based on statistical analysis, using a computer device processor, of the transaction history of the user.

21. The system of claim 14, further comprising:
an assistance routine stored in the memory, executable by the processor and configured to provide directions to the user,
wherein the directions assist the user in reaching a business associated with the offer.

22. The system of claim 14, wherein the offer is customized based on the transaction history of the user.

23. A computer program product for providing an offer based on a projected path triggered by a transaction at a point-of-transaction device, the computer program product comprising:
a computer-readable medium comprising:
a first set of codes for causing a computer to receive data associated with a transaction at a point-of-transaction device, the data comprising financial account information;
a second set of codes for causing a computer to identify a user associated with the financial account information;
a third set of codes for causing a computer to predict a projected path based at least in part on the transaction; and
a fourth set of codes for causing a computer to provide an offer to the user based at least in part on the projected path.

24. The computer program product of claim 23, wherein the projected path is predicted based on a pattern recognition analysis of transaction history of the user.

25. The computer program product of claim 24, wherein the pattern recognition analysis predicts future behavior of the user based on historical patterns of behavior present in the transaction history of the user.

26. The computer program product of claim 23, further comprising a fifth set of codes for causing a computer to determine an offer from a plurality of offers, wherein the offer is determined at least in part based on the projected path of the user.

27. The computer program product of claim 26, wherein the offer is determined based on the predicted destination of the user.

28. The computer program product of claim 23, wherein the offer is provided to the user substantially immediately after conducting the transaction at the point-of-transaction device.

29. The computer program product of claim 23, wherein the computer-readable medium is stored on a mobile device of the user.
